(19) United States
(12) Patent Application Publication
(10) Pub. No.: US 2020/0005582 A1
(43) Pub. Date: Jan. 2, 2020

(54) ON-DEMAND PROCESSING OF CHILLED FOOD PRODUCT

(71) Applicant: The Coca-Cola Company, Atlanta, GA (US)

(72) Inventors: Gregg CARPENTER, Marietta, GA (US); Kirk DAHLBERG, Atlanta, GA (US); David SLAGLEY, Roswell, GA (US); Thomas G. NORTH, III, Woodstock, GA (US); Thomas P. HOWELL, Atlanta, GA (US)

(21) Appl. No.: 16/465,388

(22) PCT Filed: Nov. 29, 2017
(86) PCT No.: PCT/US2017/063748

§ 371 Date: May 30, 2019

Related U.S. Application Data
(60) Provisional application No. 62/428,519, filed on Nov. 30, 2016.

(51) Int. Cl. G07F 17/00; A23L 3/36; F25D 3/00; F25D 11/04; F25D 25/00; F25D 29/00

(52) U.S. Cl. CPC G07F 17/0071; A23L 3/362; F25D 3/00; F25D 11/04; F25D 2600/04; F25D 29/003; A23V 2002/00; F25D 2500/06; F25D 25/00

(57) ABSTRACT

A packaged food product processing machine. The machine comprises a food consumer interface configured to receive a food consumer selection identifying an end state of a food product, a package cooling sub-system comprising a chilled fluid bath, a gripper component configured to agitate a package containing the food product in the chilled fluid bath and to sense a physical parameter of the food product, and a controller configured to command the gripper to control the rate of heat transfer from the package to the chilled fluid bath based on receiving an input identifying an end state selection from the food consumer interface and based on receiving an input containing a value of the physical parameter of the food product from the gripper component.

### CROSS-REFERENCE TO RELATED APPLICATIONS

This application claims the benefit of U.S. Provisional Patent Application Ser. No. 62/428,519 filed Nov. 30, 2016, the disclosure of which is expressly incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Food product processing machines may desirably be configured to provide food products that are uncontaminated by chemical impurities or biological agents such as bacteria, yeasts, or virus spores. Food product processing machines may desirably produce food efficiently and quickly while also providing a good tasting food product. Food product processing machines may desirably deliver the food in an attractive and presentable package for consumer purchase. Considering the wide variety of different food products provided by the food industry, designing food product processing machines to meet these objectives is often challenging.

### SUMMARY

In an embodiment, a packaged food product processing machine is disclosed. The machine comprises a food consumer interface configured to receive food consumer selections identifying an end state of the food product and a package cooling sub-system comprising a liquid fluid bath maintained at a temperature below the freezing point of the food product contained by the packages. The machine further comprises a package handling sub-system configured to receive a package of food product, to move the package to the cooling sub-system, and to move the package to a delivery point of the machine, where the package handling sub-system comprises a gripper component that is configured to grip a package of food product at an end of the package, to rotate the food package about a central axis of the package, and is coupled to a sensor that is configured to sense a physical parameter of the food product contained by the package and a control sub-system coupled to the cooling sub-system, to the package handling sub-system, and to the food consumer interface, where the control sub-system monitors physical parameters of the cooling sub-system, and the package handling sub-system and controls the gripper component of the package handling sub-system based on the monitored physical parameters and based on the physical parameter of the food product sensed by the sensor coupled to the gripper component to process the food product to attain an end state input received by the control sub-system from the food consumer interface.

In another embodiment, a method of on-demand processing of a chilled food product is disclosed. The method comprises storing a plurality of packages of food product in a storage sub-system of a packaged food product processing machine and receiving an input from a food consumer interface of the food product processing machine, where the input identifies a food product and an end state of the food product. The method further comprises retrieving one of the packages of food product from the storage sub-system based on the input that identifies the food product by a package handling sub-system of the packaged food processing machine and manipulating the package of food product by the package handling sub-system in a chilled fluid bath of a package cooling sub-system of the packaged food processing machine, wherein the manipulating comprises moving the package to promote heat transfer between a surface of the package and the chilled fluid bath and to agitate the food product inside the package to promote heat transfer between the package and the chilled fluid bath and the manipulating is controlled based on the input that identifies the end state of the food product. The method further comprises monitoring a current state of the food product within the package of food product, based on monitoring the current state of the food product, removing the package of food product from the chilled fluid bath by the package handling sub-system, and, after removing the package of food product from the chilled fluid bath, delivering the package of food product to a food consumer.

In yet another embodiment, a packaged food product processing machine is disclosed. The machine comprises a food consumer interface configured to receive a food consumer selection identifying an end state of a food product, a package cooling sub-system comprising a chilled fluid bath, a gripper component configured to agitate a package containing the food product in the chilled fluid bath and to sense a physical parameter of the food product, and a controller configured to command the gripper to control the rate of heat transfer from the package to the chilled fluid bath based on receiving an input identifying an end state selection from the food consumer interface and based on receiving an input containing a value of the physical parameter of the food product from the gripper component.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a chilled packaged food product delivery platform according to an embodiment of the disclosure.

FIG. 2A is a block diagram of an on-demand package cooling sub-system according to an embodiment of the disclosure.

FIG. 2B is a block diagram of a heat exchanger according to an embodiment of the disclosure.

FIG. 3 is an illustration of a package handling sub-system grasping a product package according to an embodiment of the disclosure.

FIG. 4A, FIG. 4B, and FIG. 4C illustrate rotational manipulation of a product package according to an embodiment of the disclosure.

FIG. 5A, FIG. 5B, and FIG. 5C illustrate exemplary adaptations of product packages according to an embodiment of the disclosure.

FIG. 6A, FIG. 6B, and FIG. 6C illustrate additional adaptations of product packages according to an embodiment of the disclosure.

FIG. 7 is a block diagram of an on-demand package cooling sub-system according to an embodiment of the disclosure.

FIG. 8 is a flow chart of a method according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The present disclosure teaches a system and method for on-demand processing of chilled food products. More specifically, a chilled packaged food product delivery platform is taught that promotes a food consumer selecting or defining an individualized chilled food preference (e.g., hard frozen, lightly frozen, smooth textured, coarse textured, soft center with firm outside, firm center with soft outside, and the like) and then performs on-demand processing of the subject food product, in response to the food consumer selection, to deliver the chilled packaged food product having the individualized food preferences selected. In an embodiment, the packaged food product delivery platform may have the form factor of a vending machine or of a food dispensing system on a counter top.

The phrase “on-demand processing of packaged food products” means that the processing is performed and completed shortly before (e.g., about 10 seconds before, about 30 seconds before, about 2 minutes before, or less than about 5 minutes before) the packaged food product is delivered to the food consumer, for example delivered to a human being. Such on-demand processing is distinct from processing of food products at a central food processing plant or factory where processed food products are then removed from the plant or factory for transportation to distribution points such as stores and restaurants. In the latter case, processing occurs hours if not days before the packaged food product is delivered to the food consumer.

The packaged food product delivery platform may be considered to process food contained within a package in the context of a closed-loop control system. In an embodiment, the platform comprises a food product storage sub-system, a package identification sub-system, a package handling and/or manipulation sub-system, a package chilling sub-system, a package delivery sub-system, a food consumer interface sub-system, and a process control sub-system. It is understood, however, that the platform may be abstracted, sub-divided, or componentized differently. Additionally, the platform may comprise additional sub-systems and/or components than those identified above. In an embodiment, the platform does not comprise a food product storage sub-system.

The platform controls physical parameters of the packaged food product over time to transform the food product from an initial state to a food consumer selected end state. The platform may manipulate and/or control a temperature gradient of the packaged food product, over time, by immersing the package in a chilled fluid bath, by controlling a rate of flow of the chilled fluid over an exterior surface of the package, by controlling the temperature of the chilled fluid bath, and by moving and/or agitating the package. The rate or acceleration of moving and/or agitating the package may be controlled and/or modulated by the platform. The platform may perform this manipulation in a closed-loop control framework that measures one or more of a temperature of the food product within the package, a flow rate of the chilled fluid, an inlet temperature of the chilled fluid (the temperature of the chilled fluid before it contacts the exterior surface of the package), an outlet temperature of the chilled fluid (the temperature of the chilled fluid after it has passed over the exterior surface of the package), a torque applied to the package, a linear force applied to the package, an angular velocity of the package, a linear velocity of the package, and possibly other parameters of the package and/or of the platform sub-systems and/or components.

The quality or end state of a delivered chilled food product is the result of the initial state of the chilled food product and the time-integrated processing performed on the package containing the chilled food product. The processing of the food product using the packaged food product delivery platform taught herein can be analogized to the performance of an orchestral score where the score lines of individual instruments correspond to the time-phased manipulations of independent physical packaged food process variables (packaged food product internal temperature, temperature gradients in the packaged food product, inlet chilled fluid temperature, outlet chilled fluid temperature, chilled fluid flow rate, torque applied to the package, linear force applied to the package, angular velocity of the package, linear velocity of the package, etc.). Just as a conductor hears the aggregated sound of all the instruments of the orchestra and urges the piccolo to increase its amplitude, admonishes the tympani to dampen out, and signals the violins to apply less vibrato, so in the packaged food product delivery platform taught herein, a controller monitors the process variables and adapts the time-phased manipulations of the package containing the chilled food product. Just as the emotional impact experienced at the conclusion of an orchestra performance depends on the series of preceding quieter and louder passages, faster and slower tempos, short, quick piano notes against the foil of slower notes from other orchestral instruments, so the quality and/or end state of the delivered chilled food product depends on the time-phased physical manipulations of the package containing the food product. Said in another way, the end state of the chilled food product is the effect not merely of its final temperature and temperature gradient but also of the pathway by which it reached its final temperature and temperature gradient from the initial state of the food product.

The chilled packaged food product delivery platform is provided with a plurality of chilled food processing recipes—“orchestral scores” for transforming the chilled food product into the desired end state, to continue the simile ventured above—that the process control sub-system uses to process the chilled food products from initial state to delivered end state. The control sub-system, for example, may receive a consumer food preference selection and index or map from this preference selection to one of the chilled food processing recipes. The consumer food preference selection may be considered to further identify a particular chilled food product, for example a raspberry slushie, a strawberry slushie, a sauerkraut slushie, a carrot juice freeze, or other product. Thus, the indexing to a chilled food processing recipe may be based both on the desired end state as well as on the selected chilled food product. Having found the appropriate processing recipe, the control sub-system executes the described food processing based on its monitoring of process variables. It is understood that the chilled food processing recipes may be increased or added to over time as new chilled food products are brought to market and/or as new food preferences are identified and defined.

It is contemplated that at least some processing of the chilled food product may be accomplished late in the process, for example at about the time the consumer is reaching for the package containing the chilled food product, or even after the package is in the hand of the consumer. This may increase the satisfaction of the consumer and/or the drama of presentation of the chilled food product. For example, the chilled food product delivery platform may be able to orchestrate nucleation of metastable (e.g., supercooled) food materials from a liquid or partially liquid state to a frozen or partially frozen state right before the food consumer's eyes. The chilled food product delivery platform may chill the chilled food product to a metastable state and then apply a nucleation stimulus to the package, for example a mechanical shock or sharp brief linear acceleration or a sonic or ultra-sonic mechanical stimulus. Nucleation is a phase change or state change of a material, for example from a fluid state to a solid state (e.g., from a liquid state to a frozen state). Nucleation may be considered to be a rapid phase change.

Producing a range of different end states of a food product from the same initial state of the food product poses various technical challenges. For example, to provide different granularity of the food product it may be desirable to chill the food product to a metastable state that is below the freezing point of the food product. Further, providing different degrees of metastability (e.g., how many degrees below the freezing point the food product is chilled) in a controlled manner may entail providing a chilled fluid that is significantly below the freezing point of the food product. While in prior art systems it may have been possible to simply allow the food product to cold saturate and achieve an equilibrium temperature roughly equal to the temperature of the chilled fluid, in the present system following this cold saturate process would chill the food product excessively. Thus, controlled chilling in a feedback control loop becomes desirable. Providing the desired granularity of the product may depend upon controlled nucleation of metastable food product. Such controlled nucleation, in the machine and/or platform taught herein, may be provided by the delivery sub-system that may provide a range of nucleation stimuli such as one or more of a sharp physical blow, a sonic signal, a laser stimulation, or other. Moreover, the frequency and/or power of the nucleation stimuli may vary over time or with different food products as defined in the food processing recipes. Nucleation may occur while the chilled food product is in the chilled fluid and/or after the chilled food product is removed from the chilled fluid.

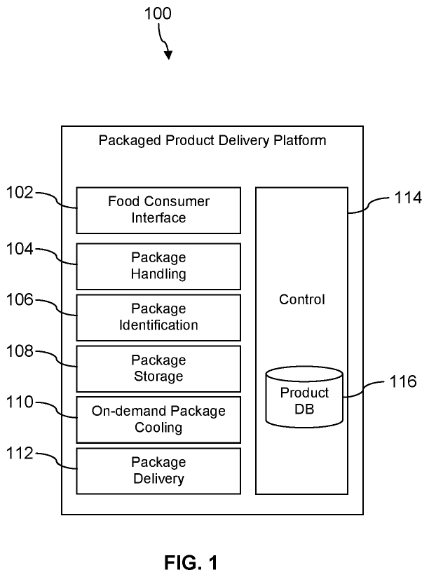

Turning now to FIG. 1, a packaged chilled food product delivery platform 100 is described. In an embodiment, the chilled food product delivery platform 100 comprises a food consumer interface 102, a package handling sub-system 104, a package identification sub-system 106, a packaged food product storage sub-system 108, an on-demand package cooling sub-system 110, a package delivery sub-system 112, and a control sub-system 114. The control sub-system 114 may be considered to incorporate or comprise a chilled food product datastore 116, for example a memory that stores a plurality of chilled food product processing recipes, instructions, or descriptions. The food consumer interface 102 provides controls for a consumer to select a chilled food product and a preference for the end state or quality of the food product. The food consumer interface 102 may be operated by the food consumer—e.g., the woman, man, or child that will eat and/or drink the chilled food product—or by an employee of a restaurant or cafeteria in which the chilled food product is delivered to the food consumer.

The packaged food product storage sub-system 108 stores packages of chilled food product. The packages may be a plurality of packages each containing the same initial food product (for example, each containing a chilled apple juice product). Alternatively, the packages may be packages at least some of which contain different initial food products (for example, some packages containing a chilled apple juice product, other packages containing a chilled cranberry juice product, other packages containing a chilled strawberry juice product, etc.). The packaged food product storage sub-system 108 may maintain the packages of chilled food product at an intermediate temperature that is cooler than room temperature but warmer than the desired temperature of the end state of the food product. For example, the packaged food product storage sub-system 108 may maintain the packages of chilled food product at about 35 degrees Fahrenheit, at about 38 degrees Fahrenheit, at about 42 degrees Fahrenheit, at about 45 degrees Fahrenheit or some other temperature. The packaged food product storage sub-system 108 may provide insulation around the stored package of chilled food products. In an embodiment, the packaged food product storage sub-system 108 may store the packages of chilled food product at room temperature or at an ambient temperature, and a package of chilled food product may be chilled during an on-demand processing stage.

It is understood that the packages of chilled food product may initially be at a higher temperature such as room temperature or even above room temperature when loaded into the packaged food product storage sub-system 108. The packaged food product storage sub-system 108 will cool the recently loaded packages of chilled food products to an equilibrium temperature of the intermediate temperature. The packaged food product storage sub-system 108 may store more than 10 but less than 500 packages of chilled food products, more than 20 but less than 400 packages of chilled food products, more than 30 but less than 300 packages of chilled food products, more than 50 but less than 150 packages of chilled food products, or some other number of chilled food products. It is understood that the number of food products may vary over time as packages are delivered to food consumers and stock of packages in the packaged food product storage sub-system 108 are replenished. When stock is depleted in the packaged food product storage sub-system 108, the packaged food product storage sub-system 108 may store less than 10 packages, for example less than 5 packages, 1 package, or zero packages. In an embodiment, the packaged food product storage sub-system 108 may report inventory stock data to the control sub-system 114, and the control sub-system 114 may report inventory stock data via a communication interface to a monitoring system or console or may send a notification to replenish the stocks.

In some embodiments, the packaged food product storage sub-system 108 may be provided as a separate system to the packaged chilled food product delivery platform 100, such as a stand-alone cooler. In some embodiments, the packaged chilled food product delivery platform 100 may not include a packaged food product storage sub-system 108.

The packaged chilled food product delivery platform 100 is contemplated for use with a variety of chilled food products. The chilled food products may comprise fruit juices and/or mixes of fruit juices. The chilled food products may comprise vegetable juices and/or mixes of vegetable juices. The chilled food products may comprise carbonated soft drinks. The chilled food products may comprise dairy products and/or flavored dairy products, such as milk products and/or yogurt products. The chilled food products may comprise water. The chilled food products may incorporate other materials such as fruit, shredded fruit, pureed fruit, chopped fruit, and fruit processed in different ways. The chilled food products may incorporate flavoring materials such as malt, honey, flavored syrups, sweeteners, nougat, fragments of chocolate, whole or pieces of nuts, fragments of hard candy, pieces of candied fruit, fragments of candied fruit peel, zest of fruit peel, or other food grade materials.

The package handling sub-system 104, under command from the control sub-system 114, may retrieve a package containing a chilled food product from the packaged food product storage sub-system 108. Alternatively, an end-user or food consumer may insert a desired packaged food product into the package handling sub-system 104, for example after retrieving the desired packaged food product from a stand-alone cooler or other storage unit (e.g., where the food product delivery platform 100 does not comprise a packaged food product storage sub-system 108). The package handling sub-system 104 may move the retrieved package past a scanner component of the package identification sub-system 106, the package identification sub-system 106 may identify the package (e.g., a package of apple juice versus a package of strawberry juice), and the package identification sub-system 106 may provide the identity, size, and/or type of the package to the control sub-system 114. In an embodiment, the geometry (e.g., shape) of the package may have an influence on the processing of the packaged food product. In an embodiment, the material composition of the package may have an influence on the processing of the packaged food product, for example different materials may exhibit different heat transfer characteristics. The package identification sub-system 106 may determine and identify the geometry of the package and/or the material composition of the package.

The package identification sub-system 106 may comprise a scanner that reads a bar code, a two-dimensional bar code, a semacode, a quick response code (QR code), a ShotCode, or other graphic located on the package and identifies the package (e.g., identifies the food product contained by the package) based on decoding and/or interpreting the graphic. The package identification sub-system 106 may comprise a camera and processor for capturing an image of the package and comparing the image to previously captured images of reference products to facilitate identifying the package. The package identification sub-system 106 may comprise a radio frequency identity (RFID) scanner that reads an RFID tag located on the package and identifies the package based on decoding and/or interpreting the RFID.

Alternatively, the package identification sub-system 106 may determine the identity of each of the packages of chilled food product stored in the packaged food product storage sub-system 108 and provide this identification of packages and their locations to the control sub-system 114. The control sub-system 114 may then command the package handling sub-system 104 to select a specific package by identifying a location of the subject package of chilled food product within the packaged food product storage sub-system 108.

The package handling sub-system 104, in response to commands received from the control sub-system 114, may move the retrieved package of chilled food product and manipulate it for processing within the on-demand package cooling subsystem 110, for example holding the package in a chilled fluid bath and agitating the package to promote efficient chilling of the chilled food product within the package. The package handling sub-system 104 may then move the processed package of chilled food product to the package delivery sub-system 112 for delivery to the consumer. In some embodiments, the package handling sub-system 104 and the package delivery sub-system 112 may be combined as a single sub-system.

The package delivery sub-system 112 may perform additional processing of the package, for example perform a nucleation processing step to stimulate a metastable chilled food product to undergo a state change or a phase change, or may merely provide the processed package for retrieval by the consumer. Alternatively, the package handling sub-system 104 may stimulate the metastable chilled food product to undergo a state change or a phase change while still positioned in the chilled fluid bath and thereafter move the processed package of chilled food product to the package delivery sub-system 112. The package handling sub-system 104 may further perform a drying and/or cleaning step after removing the package of chilled food product from the chilled fluid bath, for example rotating the chilled food product to fling off fluid and/or by blowing air over the surface of the chilled food product.

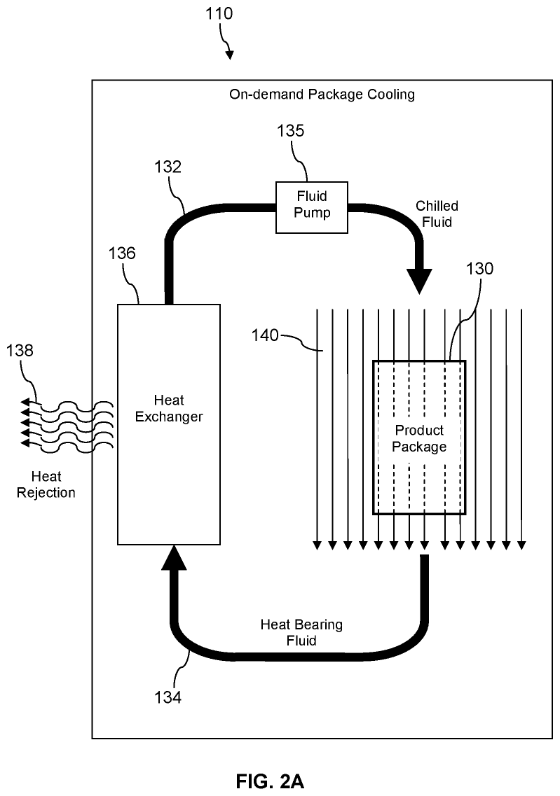

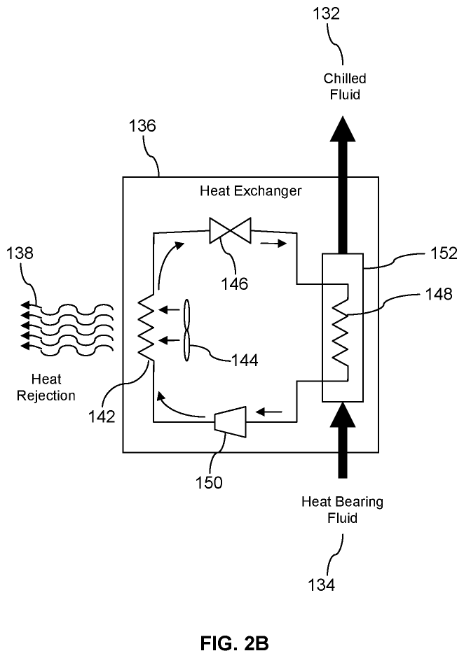

Turning now to FIG. 2A, further details of the on-demand package cooling sub-system 110 are described. In an embodiment, the on-demand package cooling sub-system 110 flows a chilled fluid stream 132 over an exterior of a product package 130. The chilled fluid stream 132 absorbs heat from the chilled food product within the product package 130 by heat transfer from the surface of the product package 130 to the fluid which results in a heat bearing fluid stream 134. In an embodiment, the on-demand package cooling sub-system 110 comprises a fluid pump 135 that circulates the fluid stream 132, 134 through a fluid bath 140 and through a heat exchanger 136. It is understood that the chilled fluid stream 132 and the heat bearing fluid stream 134 are the same fluid stream before and after, respectively, the heat transfer. The fluid stream 132, 134 may be conceptualized to constitute the fluid bath 140 in which the product package 130 is at least partially immersed.

The heat bearing fluid stream 134 is processed by the heat exchanger 136 to perform heat rejection 138 and to condition the chilled fluid stream 132. The heat exchanger 136 may employ a phase-change cooling system comprising a condenser and an evaporator. In an embodiment, the heat exchanger 136 may cool the chilled fluid stream 132 well below the freezing point of water. In an embodiment, the heat exchanger 136 may cool the chilled fluid stream 132 to about −10 degrees Fahrenheit, to about −20 degrees Fahrenheit, to about −25 degrees Fahrenheit, to about −30 degrees Fahrenheit, or to some other temperature. In an embodiment, the fluid of the fluid stream 132, 134 may comprise a propylene glycol. In an embodiment, the fluid of the fluid stream 132, 134 may comprise salt, calcium, and organic fat. In an embodiment, the fluid of the fluid stream 132, 134 desirably has a relatively high specific heat and a relatively low thermal resistance. In an embodiment, the fluid of the fluid stream 132, 134 is selected at least in part from materials that are not hazardous to human health when consumed in small amounts (e.g., in case of inadvertent or accidental consumption).

It is understood that, generally speaking, the greater the temperature differential between the chilled fluid stream 132 and the exterior surface of the product package 130, the more rapid the heat transfer away from the chilled food product (the more rapid the temperature decrease in the chilled food product). Agitation of the product package 130 in the fluid bath 140 may affect the rate of heat transfer away from the chilled food product to the chilled fluid stream 132. The rate of flow of the chilled fluid stream 132 may also affect the rate of heat transfer from the product package 130 to the chilled fluid stream 132. The control sub-system 114 may control and/or modulate the function of the fluid pump 135 to adapt the rate of flow of the fluid stream 132, 134 to achieve target process parameter values and/or in accord with a chilled food processing recipe. The control sub-system 114 may send on and off commands to the fluid pump 135. The control sub-system 114 may send speed or volume commands to the fluid pump 135. The degree to which the chilled fluid stream 132 flows smoothly over the exterior of the product package 130 (with laminar flow or with turbulence—for example as represented by a Reynolds number of the fluid flow) also affects the rate of heat transfer from the product package 130 to the chilled fluid stream 132. A specific heat and/or a thermal resistance of the fluid of the fluid stream 132, 134 may also affect the rate of heat transfer from the product package 130 to the chilled fluid stream 132. One or more of these properties may be managed by the platform 100 to process the chilled food product to achieve different end states of the chilled food product.

As a suggestion for thinking about the platform 100 and its operation, it is contemplated that the platform 100 may be designed and engineered to produce a high maximum rate of heat transfer and that the process parameters may then be controlled by the control sub-system 114 to modulate the rate of heat transfer between that maximum rate and lesser rates, whereby to achieve a variety of different desired end states of the chilled food product. For example, in an embodiment, different rates of heat transfer may affect the graininess (e.g., the size and quantity of crystals formed) of the end state of the food product so that it may be smooth or chunky textured. Either allowing heat transfer boundaries to exist in the food product during cooling or diminishing such heat transfer boundaries to exist in the food product during cooling by agitating and/or rotating the product package 130 can affect the texture of the food product. An amount of super-cooling (cooling below a temperature of a phase change for the subject food product) can affect the texture of the food product when nucleation is triggered. Controlling process parameters to produce a succession of periods of rapid heat transfer followed by periods of slower heat transfer may achieve desired end states of the chilled food product.

In an embodiment, an effective specific heat of the chilled fluid stream 132 may be reduced by infiltrating dry gas bubbles in a controlled manner into the chilled fluid stream 132. The effective specific heat of the chilled fluid stream 132 suspending dry gas bubbles may be considered to be less than the specific heat of gas free fluid and more than the specific heat of the gas in isolation. By controlling the amount of dry gas bubbles in the chilled fluid stream 132, the effective specific heat of the chilled fluid stream 132 may be modulated. It may be desirable to cut the specific heat of the chilled fluid stream 132 by the admixture of dry gas bubbles, for example, when approaching a process temperature target. Alternatively, the controlled infiltration of dry gas bubbles into the chilled fluid stream 132 may be used to modulate an effective thermal resistance of the chilled fluid stream 132. In an embodiment, the effective specific heat or an aggregate specific heat of the chilled fluid stream 132 may be reduced by mixing two different chilling fluids. It is understood that the dry gas bubbles may have a transient effect on the effective specific heat of the chilled fluid stream 132, as the dry gas bubbles may naturally separate from the fluid (rise to a surface of the fluid and escape) and may be exhausted or recycled as bubbles infiltrated into the chilled fluid stream 132.

Turning now to FIG. 2B, further details of the heat exchanger 136 are described. In an embodiment, the heat exchanger 136 comprises a condenser 142, a fan 144, an expansion valve 146, an evaporator coil 148, a compressor 150, and a fluid manifold 152. Phase change material (not shown) is housed in a chamber in thermal communication, but fluidically isolated from the evaporator coil 148. For example, phase change material may be placed in closed tubes that surround the evaporator coil 148. Therefore, the phase change material can reject heat to a refrigerant as it is circulated through the condenser 142, the expansion valve 146, the evaporator coil 148, and the compressor in a clockwise sense in FIG. 2B.

Likewise, the phase change material chamber is placed in thermal communication, but fluidically isolated from the fluid manifold. Therefore, the heat bearing fluid stream 134 can reject heat to the phase change material. As the phase change material accepts heat from the heat bearing fluid stream 134, the phase change material melts. Therefore, the phase change material may be selected to have a melting temperature at the desired temperature of the chilled fluid stream 132. Upon a portion or all of the phase change material being melted by the heat bearing fluid stream 134, the refrigerant may be circulated by the compressor 150 to re-freeze the phase change material.

The phase change material allows for multiple cooling sessions in a row while the compressor 150 is recharging the phase change material. The heat exchanger 136 using phase change cycles may desirably contribute to providing a consistent operating temperature in the cooling process, for example by cooling the cooled fluid stream 132 to a consistent temperature (e.g., the melting point of the phase change temperature). The use of the heat exchanger 136 employing phase change cycles may allow use of a reduced size fluid bath 140 relative to a fluid bath 140 designed for use in a platform 100 using an alternative heat exchanger 136 that is simply a passive radiator. The phase change material, because it is kept separated from the fluid stream 132, 134, need not be restricted to food grade substances or to substances not harmful to human beings if ingested in small quantities. This allows the phase change material to be selected from a larger variety of materials, for example materials that may be more efficient or may exhibit a more desirable phase-change temperature or working temperature.

In an embodiment the phase change material can be charged in off-peak times, and the compressor 150 need not be scaled for real-time operation. In an embodiment, the phase change material may be provided in a relatively large quantity and may be deemed to comprise a thermal battery. This thermal battery may be cooled in off-peak use times to re-freeze any melted phase change material.

In an embodiment, the refrigerant is compressed by the compressor 150. Thermal energy is removed from the refrigerant (e.g., the heat rejection 138) by the fan 144 blowing air or other heat exchange fluid over the condenser 142. The refrigerant may be compressed or condensed to a fluid by the compressor 150 and/or in the condenser 142. The cooled refrigerant is then expanded by the expansion valve 146 and flashes, at least partially, into a gas. This refrigerant at the expansion value 146 and/or in the evaporation coil 148 increases the thermal energy of the refrigerant significantly, thereby absorbing heat from the heat bearing fluid 134 and/or phase change material (e.g., the increased thermal energy in the refrigerant comes from the heat bearing fluid 134 and/or phase change material). The cycle of the refrigerant may be a continuous or an intermittent cycle. The refrigeration cycle and components within the heat exchanger 136 may be controlled by the control sub-system 114. For example, the control sub-system 114 may control the fan 144, the expansion valve 146, and the compressor 150.

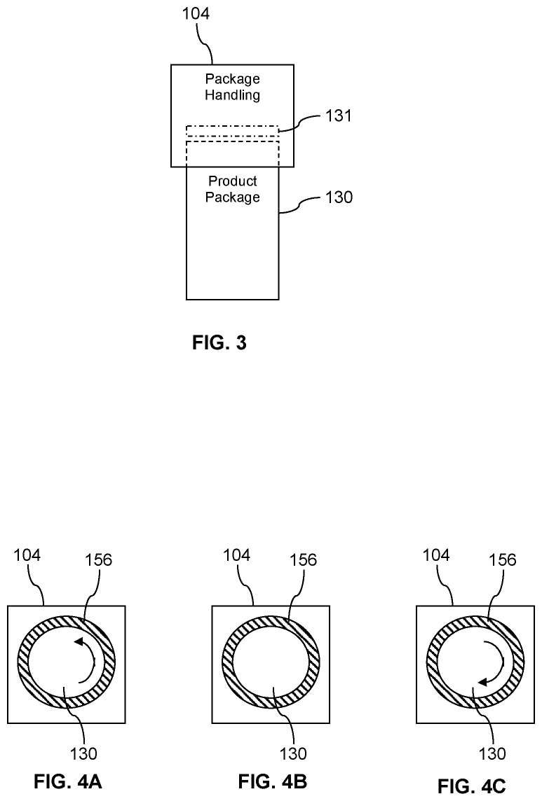

Turning now to FIG. 3, further details of the package handling sub-system 104 in contact with the product package 130 are discussed. At least a portion of the package handling sub-system 104, for example a robot arm, a manipulation arm, or other actuator having a gripping component, grasps the product package 130 to manipulate it. The gripping component may seal an access or opening of the product package 130 to prevent a consumer experiencing any undesirable textural effects or lingering flavor of contact with the chilled fluid stream 132. The package handling sub-system 104 may comprise one or more sensors 131 to measure a temperature of the chilled food product within the product package 130 and/or to measure a force applied to the product package 130 by the package handling sub-system 104. A temperature sensor may penetrate an exterior surface of the product package 130 and read the temperature of the chilled food product inside, for example a thin optical fiber may be inserted into the product package 130 to pick-up infrared radiation of the chilled food product and determine therefrom a temperature of the chilled food product. It is understood that an aperture formed to enter the product package 130 may be small. Additionally, in an embodiment, the package handling sub-system 104 may reseal the aperture when the product package 130 is released by the gripping component. Alternatively, a temperature sensor (e.g., a thermocouple) may be incorporated into the product package 130, and the package handling sub-system 104 and/or gripper component may thermally, electrically, or optically connect to leads of the temperature sensor that are accessible on the outside of the product package 130, whereby the control sub-system 114 may read the temperature of the food product within the product package 130.

When present, a first force sensor may sense a torque applied to rotate the product package 130 and an optional second force sensor may sense a linear force applied to the product package 130. The force sensors may be implemented, for example, by strain gauge devices such as piezoelectric devices. In an embodiment, an electric motor that agitates the product package 130, by rotating or linearly translating the product package 130, may provide a speed measurement (angular speed and/or linear speed) and a measurement of electric current in winds of the electric motor to the control sub-system 114, and the control sub-system 114 may infer a torque and/or acceleration applied based on the relationship between the speed measurement and the electric current in the windings of the electric motor.

Turning now to FIG. 4A, FIG. 4B, and FIG. 4C, the package handling sub-system 104 is represented as having a gripping component 156 that grasps the product package 130. The gripping component 156 may be part of or coupled to a robot arm, a manipulator arm, or another actuator component of the package handling sub-system 104. The gripping component 156 may be coupled to an electric motor or other actuator. In an embodiment, the axis of rotation of the electric motor is parallel with the longitudinal axis of the product package 130. In an embodiment, the axis of rotation of the electric motor is parallel and substantially coincident with the longitudinal axis of the product package 130. In FIG. 4A, the package handling sub-system 104 is represented as rotating the product package 130 counter-clockwise. In FIG. 4B, the package handling sub-system 104 is represented as holding the product package 130 in rotational stasis. In FIG. 4C, the package handling sub-system 104 is represented rotating the product package 130 clockwise. The package handling sub-system 104 may rotate the product package 130 around an axis of symmetry (e.g., around a vertical axis of a cylinder).

Alternatively, or in addition, the package handling sub-system 104 may move the product package 130 in different senses, for example in linear translation, pitching, and/or yawing. The package handling sub-system 104 may agitate the product package 130 under command of the control sub-system 114. The package handling sub-system 104 may rotate the product package 130 in a first rotational direction, stop the rotation of the product package 130, again rotate the product package 130 in the same first rotational direction, stop the rotation of the product package 130, and continue. Between instances of rotating the product package 130, the package handling sub-system 104 may hold the product package 130 substantially still for a dwell time with a duration commanded by the control sub-system 114. The package handling sub-system 104 may rotate the product package 130 in the first rotational direction, stop the rotation of the product package 130, rotate the product package 130 in a second rotational direction that is opposite of the first rotational direction, stop the rotation of the product package 130, and again rotate the product package 130 in the first rotational direction, and continue.

It is contemplated that the package handling sub-system 104 is able to agitate the chilled food product contained within the product package 130 by these various positional manipulations (rotating, translating, pitching, yawing, etc.). Agitating the chilled food product within the product package 130 can help to reduce the establishment of heat transfer boundary layers that may retard the rate of heat transfer from the chilled food product into the heat bearing fluid 134. It is also understood that agitating the product package 130 may also help to reduce the establishment of heat transfer boundary layers in the chilled fluid 132, 134 that may retard the rate of heat transfer from the chilled food product into the heat bearing fluid 134. Further, agitating the chilled food product within the product package 130 can be used in managing and/or controlling the formation of crystals (regions of particles of different phases, e.g., frozen crystals of food product) or graininess within the chilled food product. Said in another way, agitating the chilled food product can be used to modulate a texture or graininess of the chilled food product.

As used herein, the term agitating the chilled food product means inducing relative motion of portions, areas, or zones within the chilled food product with reference to other portions, areas, or zones within the chilled food product. This relative motion can likewise be referred to as mixing the chilled food product. The agitation may produce somewhat random flows or currents within the chilled food product contained by the product package 130, thereby promoting mixing the chilled food product and reducing thermal gradients within the chilled food product.

In an embodiment, the product package 130 may be rotated in a counter-clockwise sense (e.g., as depicted in FIG. 4A) at an angular speed between 2000 RPM and 3000 RPM, the rotation of the product package 130 may be stopped (e.g., as depicted in FIG. 4B), and then the product package 130 may be rotated at an angular speed in a clockwise sense (e.g., as depicted in FIG. 4C) at between 2000 RPM and 3000 RPM. In other embodiments, different rates of rotation can be employed. In an embodiment, the package handling sub-subsystem 104 and/or the gripping component 156 may rotate the product package 130 at an angular speed of more than 500 RPM and less than 10,000 RMP, at an angular speed of more than 800 RPM and less than 8000 RPM, at an angular speed of more than 1000 RPM and less than 5000 RPM, at an angular speed of more than 1500 RPM and less than 4000 RPM, or at some other angular speed.

The desired agitation of the chilled food product within the product package 130 in response to rotation, translation, pitch, and/or yaw of the product package 130 by the package handling sub-system 104 and/or the gripper component 156 can be promoted and/or encouraged by adaptation of the product package 130 from conventional designs. In an embodiment, one or more adaptations that promote agitation of the chilled food product within the product package 130 may be incorporated into the product package 130. Some of these adaptations may include what may be referred to as micro-features, for example small scale textural adaptations on the interior surface of the product package 130. These textural adaptations may be introduced by how a coating is applied to the interior surface of the product package 130, how the wall of the product package 130 is formed during manufacturing, or by post-manufacturing micro-machining or manipulation of the interior surface of the product package 130. The textural adaptations may comprise randomly located bumps or surface irregularities. The textural adaptations may comprise aligned shallow grooves, for example helical grooves. When the package handling sub-system 104 rotates the product package 130, the presence of the micro-features may increase the agitation experienced by the chilled food product within the product package 130 as compared to agitation experienced by the chilled food product within the product package 130 that lacks the micro-features.

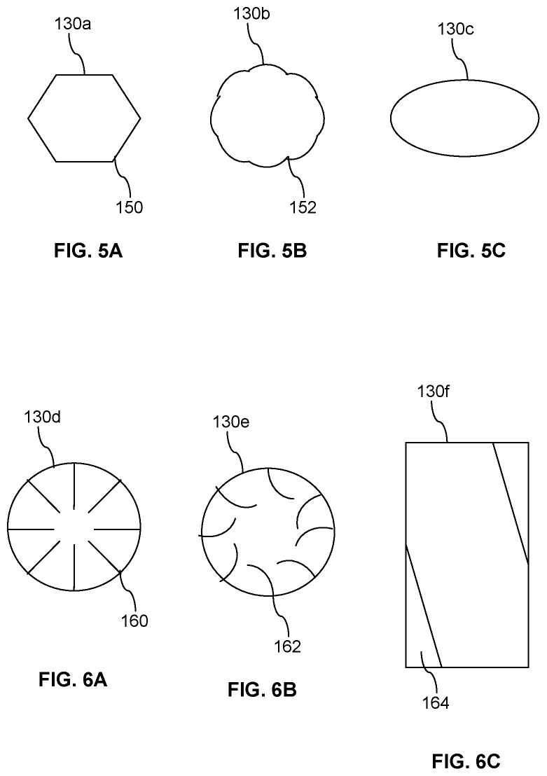

Turning now to FIG. 5A, FIG. 5B, and FIG. 5C, macro-features may be incorporated into the product package 130 to promote agitation of the chilled food product. In FIG. 5A, a vertex 150 of the walls of a product package 130a (where the walls of the product package 130 are polygonal in section) may promote increased agitation of the chilled food product when the product package 130a is rotated. While the product package 130a illustrated in FIG. 5A is hexagonal in section, in other embodiments the product package 130 may assume other polygonal sections such as triangular, square, pentagonal, septagonal, etc. In FIG. 5B, an internal rib 152 of a product package 130b may promote increased agitation of the chilled food product when the product package 130b is rotated. In FIG. 5C, an oval shape of a product package 130c may promote increased agitation of the chilled food product when the product package 130c is rotated. Yet other macro-feature adaptation of the product package 130 may contribute to agitation of the chilled food product when the product package 130 is rotated.

Turning now to FIG. 6A, FIG. 6B, and FIG. 6C, other macro-features that may be incorporated into the product package 130 are described. In FIG. 6A, a product package 130d comprises a plurality of vertical vanes 160. The vertical vanes 160 may promote increased agitation of the chilled food product when the product package 130d is rotated. In an embodiment, the walls of the product package 130d may comprise metal material and the vertical vanes 160 may comprise metal material. In an at least partially metal product package 130d, the vanes 160 may contribute to an increased rate of heat transfer from the chilled food product to the heat bearing fluid 134. In FIG. 6B, a product package 130e comprises a plurality of at least partially deformable vertical vanes 162. When the product package 130e is rotated, the deformable vertical vanes 162 deform partially and restore to a position similar to that of the vanes illustrated in FIG. 6A, thereby providing an agitation effect to the chilled food product, thereby promoting increased agitation of the chilled food product. In FIG. 6C, a product package 130f comprises diagonally disposed vanes 164. The diagonally disposed vanes 164 may promote increased agitation of the chilled food product when the product package 130f is rotated. In an embodiment, the vanes 160, 162, 164 may incorporate apertures to promote increased agitation of the food product. In an embodiment, apertures in adjacent vanes 160, 162, 164 within the product package 130 may be staggered to promote increased agitation of the food product.

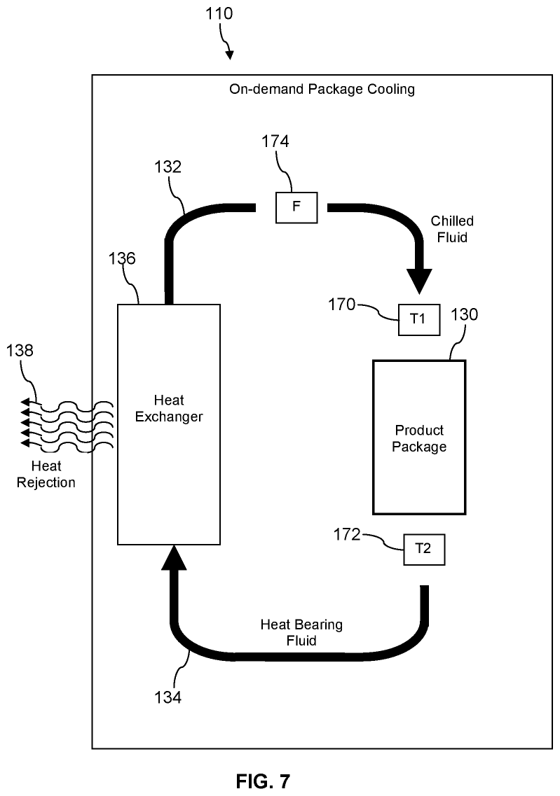

Turning now to FIG. 7, further details of the on-demand cooling sub-system 110 are described. While the fluid bath 140 is not illustrated in FIG. 7, it may be assumed to be present but removed here to permit more clearly illustrating additional features. In FIG. 7, sensors that measure process variables are illustrated. In an embodiment, the on-demand cooling sub-system 110 further comprises one or more of an inlet fluid temperature sensor 170, an outlet fluid temperature sensor 172, and a fluid flow sensor 174. Other sensors (not shown) may be provided within the heat exchanger 136. In an embodiment, the control sub-system 114 may infer a temperature of the chilled food product within the product package 130 based on a time-integration of the flow rate (mass flow rate) measured by the fluid flow sensor 174, the inlet temperature sensed by the inlet fluid temperature sensor 170, and the outlet temperature sensed by the outlet fluid temperature sensor 172.

This inference of temperature of the chilled food product, for example, may be based on an initial measured or assumed temperature of the chilled food product and on determining heat calories rejected from the food package 130. Alternatively, a like kind of determination may be arrived at by analyzing heat rejection 138 and based at least in part on the fluid mass flow rate. Alternatively, a temperature of the chilled food product may be inferred from analysis of a torque or force applied to the product package 130 by the package handling sub-system 104 and from a velocity of the product package 130, for example by inferring a viscosity of the food product.

Other parameters of the food product may be inferred from process parameters that may be directly sensed. For example, a viscosity of the food product may be inferred from a torque applied to rotate the food package 130 or from an electric current in windings of an electric motor that rotates the food package 130. The viscosity of the food product may be a process parameter used by the control sub-system 114 to control a desired texture of the end state of the chilled food product.

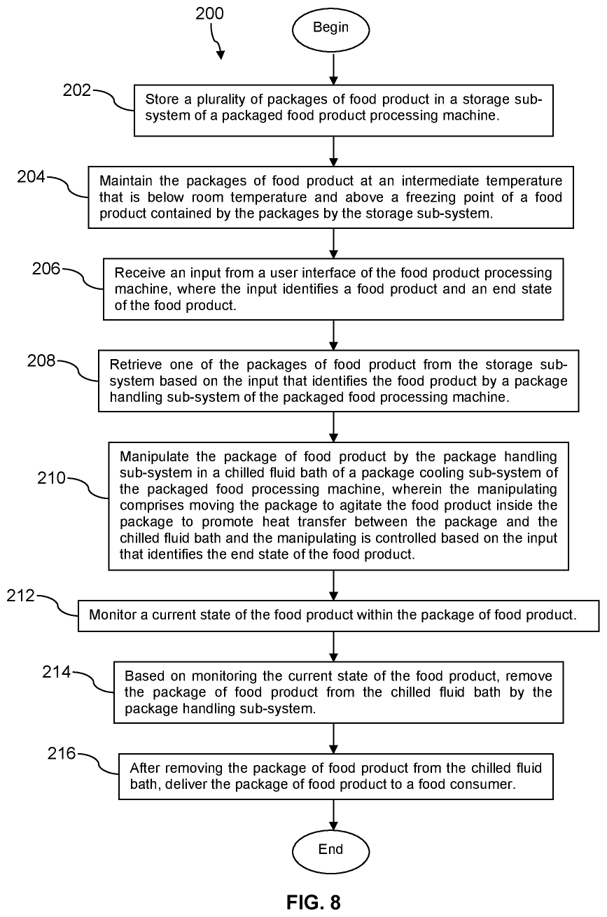

Turning now to FIG. 8, a method 200 for on-demand processing of a chilled food product is described. The method 200 may be performed, at least in part, by the packaged chilled food product delivery platform 100 described above. At block 202, a storage sub-system of a packaged food product processing machine stores a plurality of packages of food product. Alternatively, the storage of packages of food product is provided separately from the packaged food product processing machine. At block 204, the storage sub-system maintains the packages of food product at an intermediate temperature that is below room temperature and above a freezing point of a food product contained by the packages. It is understood that the packages of food product may be at or even above room temperature when initially loaded into the storage sub-system. The storage sub-system is expected to cool the initially warm packages to equilibrium at the intermediate temperature and thereafter maintain the packages at the intermediate temperature. In some embodiments, the processing of block 204 may not be provided. In some embodiments, the processing of block 204 may be performed by a storage unit which is not part of the packaged chilled food product delivery platform 100.

At block 206, an input from a food consumer interface of the food product processing machine is received, where the input identifies a food product and an end state of the food product. For example, the input may specify one of a hard frozen end state, a lightly frozen end state, a smooth textured end state, a coarse textured end state, a soft center with firm outside end state, a firm center with soft outside end state, or other end state of the chilled food product. The input may specify one of a cold product, frosty product, icy product, or frozen product. The input may further identify which of a plurality of different food products that is desired, for example select an apple juice food product, a raspberry juice food product, a mixed apple-strawberry juice food product, a carrot juice product, a vanilla malt food product, or the like.

At block 208, a package handling sub-system of the packaged food processing machine retrieves one of the packages of food product from the storage sub-system based on the input that identifies the food product. The package handling sub-system may be commanded and/or controlled by a control sub-system of the packaged food processing machine.

At block 210, the package handling sub-system manipulates the package of food product in a chilled fluid bath of a package cooling sub-system of the packaged food processing machine, wherein the manipulating comprises moving the package to agitate the food product inside the package to promote heat transfer between the package and the chilled fluid bath and the manipulating is controlled based on the input that identifies the end state of the food product. At block 212, a current state of the food product within the package of food product is monitored. This monitoring may comprise monitoring a temperature of the food product. This monitoring may comprise monitoring a metastable state of the food product, for example determining if at least some of the food product is in a metastable state. At block 214, based on monitoring the current state of the food product, the package handling sub-system removes the package of food product from the chilled fluid bath.

For example, the control sub-system monitors one or more process parameters and commands the package handling sub-system to manipulate the package of food product to reach the end state of food product desired. The control sub-system may function or execute according to process control recipes, instruction sets, or descriptions contained in a datastore. The control sub-system may select one of a plurality of recipes, instruction sets, or descriptions to execute based on the input from the food consumer interface received in block 206. The control sub-system may further manipulate other process parameters such as a rate of flow of the fluid stream 132, 134, a temperature of the fluid stream 132, 134, and an effective specific heat of the fluid stream 132, 134. The control sub-system may control the process to agitate (e.g., rotate, translate, yaw, or pitch) the package at a first time and for a first duration, to hold the package steady at a second time and for a second duration, to infiltrate dry gas bubbles into the fluid stream 132, 134 to modulate an effective specific heat of the fluid stream 132, 134 at a third time and for a third duration, and the like.

The control sub-system may further command or control the package handling sub-system to trigger nucleation, state change, or phase change in the food product. This may entail the package handling sub-system introducing nucleation triggering materials into the package of chilled food product. This may entail the package handling sub-system releasing nucleation triggering materials already stored inside the package of chilled food product. This may entail the package handling sub-system 104 or the package delivery sub-system 112 subjecting the package to a nucleation input, for example a mechanical shock that triggers nucleation, a sonic signal that triggers nucleation, radiation with an electromagnetic signal that triggers nucleation, or radiation by a laser beam that triggers nucleation. The control sub-system may cool the food product to a metastable state (cooled below a phase change temperature limit) before initiating the nucleation. For example, a sonic cone component of the package delivery sub-system 112 may apply a sonic stimulus to the food product. Nucleation may be triggered and/or stimulated while the package of food product is in the chilled fluid bath or after removal from the chilled fluid bath. It is understood that nucleation may occur over a duration of time and hence nucleation may begin in response to a short duration nucleation signal or triggering stimuli and nucleation continue after the short duration nucleation signal or triggering stimuli ceases.

At block 216, after removing the package of food product from the chilled fluid bath, the package of food product is delivered to a food consumer. For example, the package of food product may be removed from the packaged chilled food product delivery platform 100 by a human being and eaten or drunk. Alternatively, a cook or member of a wait staff of a restaurant may remove the package of food product from the packaged chilled food product delivery platform 100 and deliver the package of food product to a human being who then eats or drinks the food product. In an embodiment, after removal from the chilled fluid bath, the package handling sub-system may dry the package before the package of food product is delivered to the food consumer, the cook, or the member of the wait staff. For example, the package handling sub-system may rotate the food package after removal from the chilled fluid bath to fling off adhered droplets of the chilled fluid. Alternatively, the package handling sub-system or the package delivery sub-system may subject the package to air blowing to dry the package. In some cases, nucleation, state change, and/or phase change of the food product may occur concurrently with or after the activity of block 216, for example before the eyes of the food consumer.

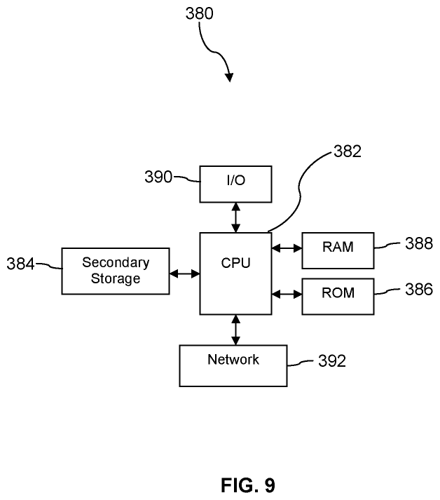

FIG. 9 illustrates a computer system 380 suitable for implementing one or more embodiments disclosed herein, for example for implementing the control sub-system 114 described above. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A packaged food product processing machine, comprising:
a food consumer interface configured to receive food consumer selections identifying an end state of the food product;
a package cooling sub-system comprising a liquid fluid bath maintained at a temperature below the freezing point of the food product contained by the packages;
a package handling sub-system configured to receive a package of food product, to move the package to the cooling sub-system, and to move the package to a delivery point of the machine, where the package handling sub-system comprises a gripper component that is configured to grip a package of food product at an end of the package, to rotate the food package about a central axis of the package, and is coupled to a sensor that is configured to sense a physical parameter of the food product contained by the package; and
a control sub-system coupled to the cooling sub-system, to the package handling sub-system, and to the food consumer interface, where the control sub-system monitors physical parameters of the cooling sub-system and the package handling sub-system and controls the gripper component of the package handling sub-system based on the monitored physical parameters and based on the physical parameter of the food product sensed by the sensor coupled to the gripper component to process the food product to attain an end state input received by the control sub-system from the food consumer interface.

2. The packaged food product processing machine of claim 1, wherein the gripper component is configured to rotate the food package at an angular speed that is greater than 500 revolutions per minute (RPM).

3. The packaged food product processing machine of claim 1, wherein the gripper is configured to seal a portion of the package of food product against contact with the liquid fluid bath.

4. The packaged food product processing machine of claim 1, wherein the gripper comprises the sensor and the sensor is configured to sense one of a temperature of the food product contained by the package or to sense a torque applied to the package to rotate the package.

5. The packaged food product processing machine of claim 1, further comprising a package delivery sub-system configured to trigger nucleation of the food product within the package, where nucleation is a rapid phase change of at least a part of the food product within the package.

6. A method of on-demand processing of a chilled food product, comprising:
storing a plurality of packages of food product in a storage sub-system of a packaged food product processing machine;
receiving an input from a food consumer interface of the food product processing machine, where the input identifies a food product and an end state of the food product;
retrieving one of the packages of food product from the storage sub-system based on the input that identifies the food product by a package handling sub-system of the packaged food processing machine;
manipulating the package of food product by the package handling sub-system in a chilled fluid bath of a package cooling sub-system of the packaged food processing machine, wherein the manipulating comprises moving the package to promote heat transfer between a surface of the package and the chilled fluid bath and to agitate the food product inside the package to promote heat transfer between the package and the chilled fluid bath and the manipulating is controlled based on the input that identifies the end state of the food product;
monitoring a current state of the food product within the package of food product;
based on monitoring the current state of the food product, removing the package of food product from the chilled fluid bath by the package handling sub-system; and
after removing the package of food product from the chilled fluid bath, delivering the package of food product to a food consumer.

7. The method of claim 6, further comprising maintaining the packages of food product at an intermediate temperature that is below room temperature and above a freezing point of a food product contained by the packages by the storage sub-system.

8. The method of claim 6, wherein the package handling sub-system manipulates the package of food product in the chilled fluid bath by rotating the package about a central axis of the package at an angular rate of at least 500 revolutions per minute (RPM).

9. The method of claim 6, wherein the package handling sub-system manipulates the package of food product in the chilled fluid bath by first rotating the package about a central axis of the package in a first angular direction, by second stopping rotating the package, and by third rotating the package about the central axis of the package in a second angular direction, where the second angular direction is opposite to the first angular direction.

10. The method of claim 6, wherein the package of food product is removed from the chilled fluid bath when the monitoring indicates that at least some of the food product contained by the package is in a metastable state, and further comprising triggering nucleation in the food product, where nucleation is a rapid phase change of at least a part of the food product within the package.

11. The method of claim 6, further comprising modulating an effective specific heat of the chilled fluid bath by controlled infiltration of gas bubbles into the chilled fluid bath.

12. The method of claim 6, further comprising chilling the chilled fluid bath to a temperature less than about −10 degrees Fahrenheit.

13. A packaged food product processing machine, comprising:
a food consumer interface configured to receive a food consumer selection identifying an end state of a food product;
a package cooling sub-system comprising a chilled fluid bath;
a gripper component configured to agitate a package containing the food product in the chilled fluid bath and to sense a physical parameter of the food product; and
a controller configured to command the gripper to control the rate of heat transfer from the package to the chilled fluid bath based on receiving an input identifying an end state selection from the food consumer interface and based on receiving an input containing a value of the physical parameter of the food product from the gripper component.

14. The packaged food product processing machine of claim 13, wherein the food consumer interface is configured to receive a food consumer selection identifying an end state selected from one or more of cold product, frosty product, icy product, or frozen product.

15. The packaged food product processing machine of claim 13, wherein the gripper component is further configured to position the package in the chilled fluid bath, to remove the package from the chilled fluid bath, and to dry the package after removing it from the chilled fluid bath.

16. The packaged food product processing machine of claim 13, wherein the gripper component is further configured to position the package in the chilled fluid bath and to remove the package from the chilled fluid bath, and wherein the controller is further configured to command the gripper to induce nucleation in the food product after removing the package from the chilled fluid bath or while the food product is positioned in the chilled fluid bath.

17. The packaged food product processing machine of claim 13, wherein the package cooling sub-system further comprises a gas infiltration component that promotes modulating an effective specific heat of the chilled fluid bath by controlled introduction of gas bubbles into the chilled fluid bath.

18. The packaged food product processing machine of claim 13, wherein the gripper component is configured to sense a temperature of the food product contained by the package.

19. The packaged food product processing machine of claim 13, wherein the food consumer interface is configured to receive a food consumer selection of a food product type, and wherein the controller commands the gripper to control the rate of heat transfer from the package to the chilled fluid bath further based on receiving an input identifying the selection of the food product from the food consumer interface.

20. The packaged food product processing machine of claim 13, wherein the food product is one of a fruit juice, a vegetable juice, a soft-drink, a carbonated soft-drink, a dairy drink, a milk drink, a yogurt product, or water.
